(19) United States
(12) Patent Application Publication
(10) Pub. No.: US 2022/0366319 A1
(43) Pub. Date: Nov. 17, 2022

(54) IN-MEMORY COMPUTATION OF ALGEBRAIC MACHINE LEARNING

(71) Applicant: Algebraic AI S.L., Madrid (ES)

(72) Inventors: Fernando Martin-Maroto, Caxias (PT); Nabil Abderrahman-Elena, Malaga (ES); Gonzalo Garcia de Polavieja Embid, Lisbon (PT)

(73) Assignee: Algebraic AI S.L., Madrid (ES)

(21) Appl. No.: 17/743,332

(22) Filed: May 12, 2022

Related U.S. Application Data
(60) Provisional application No. 63/189,362, filed on May 17, 2021.

(51) Int. Cl. G06N 20/20

(52) U.S. Cl. CPC G06N 20/20

(57) ABSTRACT

In-memory computation of algebraic machine learning, such as computation of selected operations on data directly in RAM memory without need of transferring the data to a processor, enables higher internal bandwidth, more parallelism, and better energy efficiency, e.g., when performing operations related to large scale machine learning.

### PRIORITY APPLICATIONS

This application claims priority to or the benefit of the following application: U.S. Provisional Patent Application No. 63/189,362, entitled, “In-Memory Computation of Algebraic Machine Learning”, filed 17 May 2021 (Attorney Docket No. MARO 1001-1). The priority application is hereby incorporated by reference for all purposes.

### INCORPORATIONS

The following materials are incorporated by reference for all purposes: U.S. patent application Ser. No. 16/480,625, titled “Method for Large-Scale Distributed Machine Learning Using Formal Knowledge and Training Data”, filed 2019 Jan. 17, published as US 2019/0385087.

### FIELD

The technology disclosed relates to efficient hardware implementations of machine learning.

### BACKGROUND

Improved processing techniques are needed to enable more efficient large scale machine learning.

### BRIEF DESCRIPTION OF THE DRAWINGS

FIG. 1 illustrates selected details of an algebraic machine learning engine using in-memory computation of algebraic machine learning.

FIG. 2 illustrates a processing pipeline for in-memory computation of algebraic machine learning.

FIG. 3 illustrates a hardware setup implementing in-memory computation of algebraic machine learning.

### DETAILED DESCRIPTION

This technology disclosed herein extends and expands upon technology described in U.S. Patent Application Pub. No.: US 2019/0385087. The system herein uses in-memory processing techniques to increase the efficiency of the method for large scale distributed machine learning of patent application Pub. No.: US 2019/0385087.

Example implementation technologies include DRAM (Dynamic Randomly Accessible read/write Memory), ASIC (Application Specific Integrated Circuits), FPGA (Field Programmable Gate Array), PCM (Phase Change Memory), IDAO (in-DRAM AND-OR), PCI (Peripheral Component Interconnect), AGP (Accelerated Graphics Port), and HMC (Hybrid Memory Cube).

In-memory processing is the name given to the computing of selected operations on data directly in the RAM memory without the need of transferring the data to the processor. Direct in-memory computation has advantages as the latency time of data transfer from RAM to the processor is the main performance bottleneck for many applications. In memory processing offers higher internal bandwidth, more parallelism, and better energy efficiency.

In application Pub. No.: US 2019/0385087 and in reference [ref1], the use of bit-arrays to represent the atomization of an algebra is described, including implementations in which the algebraic output models are represented within the memory or circuitry of the computing devices using a collection of bit-arrays, and the computation of the algebraic output models use array-wide bitwise operators OR, AND, and NOT operating over the bit-arrays.

Technology described herein includes reorganizing the computation of the bit-arrays of Pub. No.: US 2019/0385087 in order to more optimally perform said computation using an in-memory processing approach.

First, we maintain the representation of the atomization as an array of objects (named atoms), each having one or more bit-arrays. One of the bit-arrays represents, in a computing device memory, the upper constant segment of an atom, said upper constant segment and said atom are defined in Pub. No.: US 2019/0385087 and in reference [ref3]. Said bit-arrays sufficing to implicitly represent the graph of Pub. No.: US 2019/0385087. An auxiliary data structure can be used, the data structure comprising the inverse mapping from the constant in the upper constant segments to the atoms in said array of objects.

With said representation of the atomization, every operation on the data required to compute the algebraic output models of Pub. No.: US 2019/0385087 becomes either 1—an array-wide copy of a bit-array or 2—an array-wide logic bit-array operation on one or more bit-arrays or 3—an array-wide initialization (typically zeroing) operation. Said logic operation refers to array-wide bitwise OR, AND, NOT, or logically equivalent operations, such as NAND, NOR, or XOR. Said array-wide copy operations and said bit-array operations and zeroing operation can be carried out directly in the memory of a computing device following standard in-memory processing procedures such as RowClone [ref4] or Ambit [ref5]. Said device memory typically comprising one or many volatile RAM memory chips or non-volatile memory chips or a combination of volatile and non-volatile memory chips and one or many dedicated memory controller circuits.

In-memory processing techniques, also called processing using memory techniques, like Ambit [ref5], enable the calculation of bitwise operations completely inside a DRAM, exploiting the full internal DRAM bandwidth. Ambit uses simultaneous activation of three DRAM rows that share the same set of sense amplifiers. Said simultaneous activation enables the system to perform bitwise AND and OR operations. Ambit also uses the inverters present inside the sense amplifier to perform bitwise NOT operations. The use of the inverters in the sense amplifier and the simultaneous activation of rows enables computing AND, OR, and NOT operations that, collectively, suffice to calculate any array-wide bitwise operation. Not only the array-wide operation can be calculated efficiently but also using commodity DRAM and using the same modern DRAM interface without any changes so it can be directly plugged onto the memory bus.

Pinatubo is another in-memory processing technique meant to perform bulk bit-wise operations inside Phase Change Memory (PCM) [ref6]. Pinatubo provides mechanisms for bitwise operations and other operations such as 3-bit full adder, completely inside a memristor array.

The in-DRAM AND-OR mechanism (IDAO) is another in-memory processing technique to circumvent the need for large size data transfers on the memory channel to perform AND and OR bulk bit-wise operations [ref7,ref8]. Similar to RowClone [ref4], IDAO claims to deliver an order of magnitude improvement in the performance of said bit-wise operations.

Unlike with most common in-memory processing applications, for the calculation of machine learning of this technology (e.g., the calculation of distributed machine learning) the main processor does not need to be coupled to the memory by means of a high-performance bus. Since all the processing occurs in-memory, there is never a need to transfer the bit-arrays to the processor. A low bandwidth bus or an indirect connection between processor and RAM memory using a secondary circuit suffices. Direct or indirect input from the processor into the memory and output from the memory to the processor is still needed, but the bandwidth and latency of said input and output have no impact in the overall performance of the system.

With this technology, the task of the main processor (or processors) can be limited to the dispatch of high-level commands received and executed by an in-memory processing dedicated memory controller circuit that transform said high level commands into a series of array-wide bit-array operations in one or many memory chips. Multiple in-memory processing dedicated memory controller circuits, each close to a memory chip(s), can operate in parallel, providing a scalable architecture with no limit in the amount of memory used.

The memory circuits and the in-memory processing dedicated memory controller circuits form collectively a hybrid storage and processing unit. Seen from the processor's perspective, said hybrid storage and processing unit is 1—an abstract container of bit-arrays and, 2—a co-processor that performs full array-wide bitwise logic operations on the bit arrays. Said hybrid storage and processing unit can be fabricated in an independent circuit board and sold as an Algebraic Machine Learning dedicated co-processor that can be connected to a computer using an expansion bus such as PCI, AGP or PCI-Express. DRAM or even more advanced Hybrid Memory Cube (HMC) or 3D-stacked DRAMs can potentially be used to store and manipulate the bit-arrays in the hybrid store and processing unit.

The memory controllers in the hybrid storage and processing unit may further comprise a dedicated high-performance compression and decompression circuit in order to maintain the bit-arrays compressed in memory and optimize the use of memory resources. In this set-up, bit-arrays can be either on a compressed or in a decompressed state. Bit array compression [ref9] can significantly improve the memory usage as some bit-arrays may be highly sparse (sparse meaning that they have the same bit value, typically a 0, for most bit addresses)

The hybrid storage and processing unit may further comprise one or many dedicated internal processors. Said internal processors providing higher-level commands, said commands triggering each a series of array-wide bit-array operations dispatched by said internal processors, said commands corresponding to operations meant to calculate the algebraic output models of Pub. No.: US 2019/0385087. The said dedicated internal processors may also take care of relocation of bit-arrays, automatic compression of infrequently used bit-arrays and memory clean up.

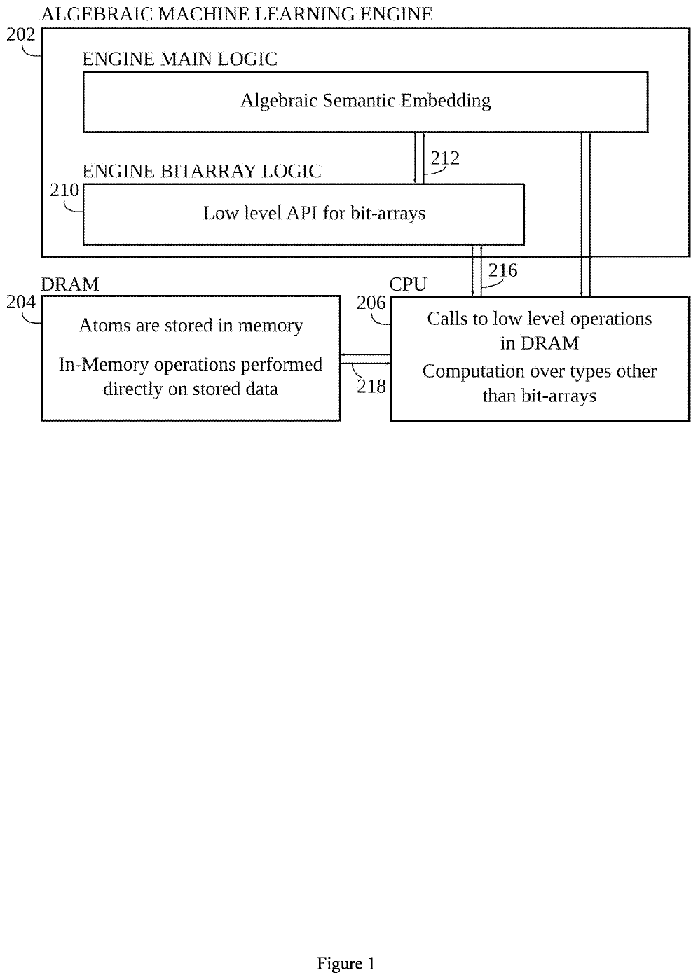

We describe, as represented in FIG. 1, a technique of distributed machine learning of Pub. No.: US 2019/0385087 computed using algebraic machine learning engine 202 comprising lower-level software 210 and hardware layer 204 206 that stores and operates on bit-arrays, said bit-arrays and operations over the bit-arrays occurring in dedicated hardware such as DRAM memory 204 by means of in-memory processing techniques, said lower-level software 210 and hardware layer 204 206 exposing an API 212 that enables 216 218 comparing, copying, and performing array-wide bitwise operations over the bit-arrays, the bit arrays always kept in said lower-level software and hardware layer, the bit arrays never or seldom transferred to the computer processor.

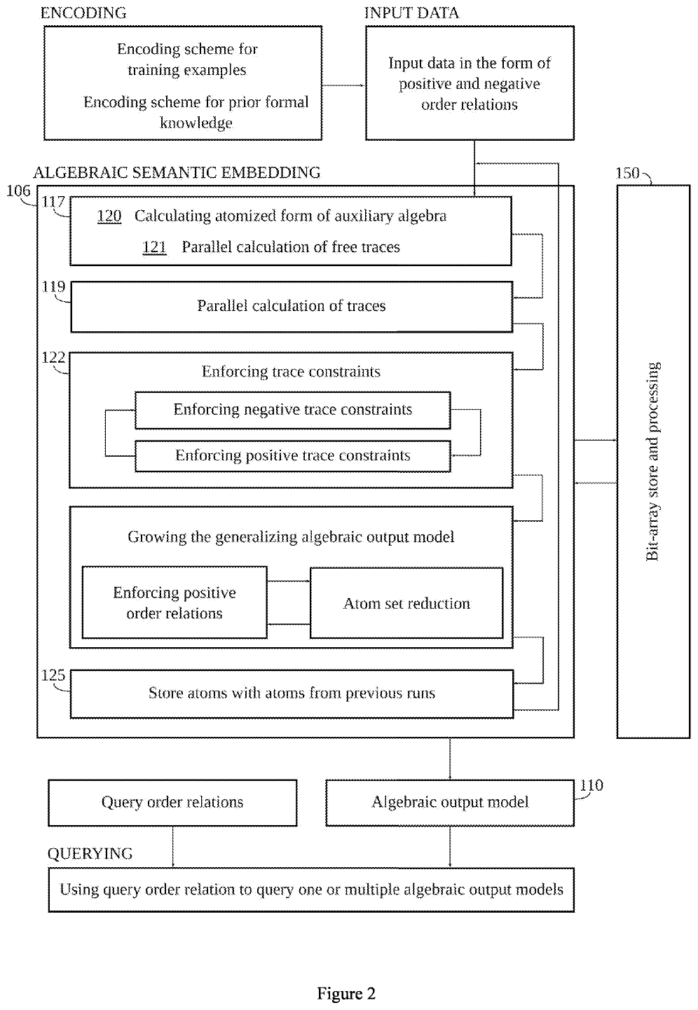

We describe, as represented in FIG. 2, a technique of distributed machine learning of Pub. No.: US 2019/0385087, organized as in Pub. No.: US 2019/0385087 and further comprising: A—the algebras and graphs of Pub. No.: US 2019/0385087 kept always in the form of bit arrays, B—the different stages of the program 106 all dispatching orders to the lower-level software and hardware layer 150 each dispatched order producing one or multiple operations over said bit-arrays, C—the computation of the auxiliary algebra 120 further comprising the step of computing free-traces in parallel 121, said free traces equal to the lower atomic segments of the auxiliary algebra of Pub. No.: US 2019/0385087, said free traces in the form of bit arrays stored and computed in the lower-level software and hardware layer 150, D—the enforcing of trace constraints 122 of application of Pub. No.: US 2019/0385087 further comprising a preliminary step of computing the traces in parallel 119, said traces defined in Pub. No.: US 2019/0385087, said traces represented as bit-arrays, said bit-arrays stored and computed in the lower-level software and hardware layer 150, E—the calculation and storing of pinning terms and relations of Pub. No.: US 2019/0385087 replaced by the equivalent storing of the atoms of the algebraic output model 125, said atoms each represented as one or many bit-arrays, F—the graphs of Pub. No.: US 2019/0385087 represented by the atoms of the algebraic output model 110, said atoms each represented as one or many bit-arrays.

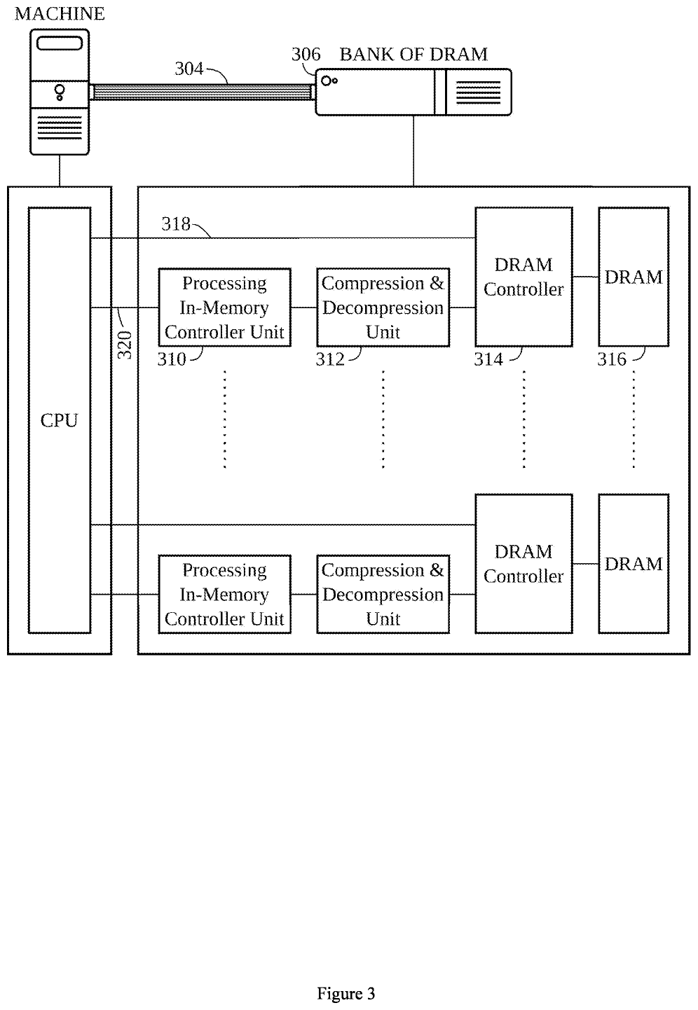

We describe, as represented in FIG. 3, a system enabled to compute the method of distributed machine learning of Pub. No.: US 2019/0385087, said system using in-memory processing, said in-memory processing occurring either in the computer's DRAM memory 316 or in an ASIC and/or an FPGA card or in an external board, said external board with one or many dedicated memory banks 306, said memory banks with auxiliary circuits for memory control 310 314 and compression and decompression of bit-arrays 312, said external board coupled to the computer main bus with an interface such as PCIe 304 318 320.

### OTHER INCORPORATIONS

The following materials are incorporated by reference for all purposes:
[ref1] Fernando Martin-Maroto. Method for large-scale distributed machine learning using formal knowledge and training data, 2019. US Patent Application US20190385087A1, U.S. Ser. No. 16/480,625.
[ref2] Fernando Martin-Maroto, G. G. de Polavieja, 2018. Algebraic Machine Learning. arXiv preprint arXiv:1803.05252.
[ref3] Fernando Martin-Maroto, G. G. de Polavieja, 2021. Finite Atomized Semilattices. arXiv preprint arXiv:2102.08050.
[ref4] Chris Fallin, Donghyuk Lee, Rachata Ausavarungnirun, Gennady Pekhimenko, Yixin Luo, Onur Mutlu, Phillip B. Gibbons, Michael A. Kozuch, Todd C. Mowry, Vivek Seshadri, Yoongu Kim. Rowclone: fast and energy-efficient in-DRAM bulk data copy and initialization. MICRO-46: Proceedings of the 46th Annual IEEE/ACM International Symposium on Microarchitecture, December 2013, pp 185-197.
[ref5] Thomas Mullins, Hasan Hassan, Amirali Boroumand, Jeremie Kim, Michael A. Kozuch, Onur Mutlu, Phillip B. Gibbons, Todd C. Mowry, Vivek Seshadri, Donghyuk Lee. Ambit: in-memory accelerator for bulk bitwise operations using commodity DRAM technology. Micro-50 '17: Proceedings of the 50th Annual IEEE/ACM International Symposium of Microarchitecture, October 2017, pp 273-287.
[ref6] Qiaosha Zou, Jishen Zhao, Yu Lu, Yuan Xie, Shuangchen Li, Cong Xu. Pinatubo: a processing-in-memory architecture for bulk bitwise operations in emerging non-volatile memories. 2016 53rd ACM/EDAC/IEEE Design Automation Conference (DAC), June 2016, pp 1-6.
[ref7] Amirali Boroumand, Donghyuk Lee, Michael A. Kozuch, Onur Mutlu, Phillip B. Gibbons, Vivek Seshadri, Kevin Hsieh, Todd C. Mowry. Fast Bulk bitwise AND and OR in DRAM. IEEE Computation Architecture Letters, 14(2):127-131, July 2015.
[ref8] Onur Mutlu, Vivek Seshadri. In-DRAM bulk bitwise execution engine. In: (https) Harxiv.org/pdf/1905.09822.pdf,
[ref9] Habib, Ahasn, Mohammed J. Islam, and M. Shahidur Rahman. “Huffman based code generation algorithms: data compression perspectives.” J. Comput. Sci 14.12 (2018): 1599-1610.

What is claimed is:

1. A method for distributed machine learning, the method comprising:
storing input data representing formal knowledge, training data, or both;
calculating discrete algebraic output models of the input data in a plurality of computing devices, a portion of computing devices of the plurality of computing devices working on a shared learning task;
sharing asynchronously indecomposable components of independently calculated algebraic models among the portion of computing devices; and
updating respective discrete algebraic output models in the portion of computing devices using the shared indecomposable components;
wherein the algebraic output models are represented within memory of the computing devices using a collection of bit-arrays, and the calculation of the algebraic output models uses array-wide bitwise operators operating over the collection of bit-arrays executed using in-memory processing.

2. The method of claim 1, wherein the shared learning task comprises a particular shared learning task and one or more related learning tasks related to the particular shared learning task.

3. The method of claim 1, wherein the array-wide bitwise operators comprise any combination of OR, AND, and NOT array-wide bitwise operators.

4. The method of claim 1, wherein the portion of computing devices comprises one or more algebraic machine learning co-processors.

5. The method of claim 1, wherein the bit arrays are each partitioned into a plurality of segments, each segment is stored in a respective RAM memory bank and the array-wide bitwise operators operating is carried out at least partially in parallel with respect to each of the segments.

6. The method of claim 1, wherein the bit arrays are each partitioned into a plurality of segments, each segment is stored in a respective RAM memory bank and the array-wide bitwise operators operating is carried out independently with respect to each of the segments.

7. The method of claim 1, wherein the in-memory processing is implemented at least in part via one or more memory banks enabled to store and operate on the collection of bit-arrays, each bit-array representing a set of directly indecomposable components of an idempotent algebra, and the memory banks are comprised in dedicated hardware that is usable as a machine learning co-processor.

8. The method of claim 7, wherein the in-memory processing is further implemented at least in part via one or more compression circuits and one or more decompression circuits, the compression circuits are enabled to reduce memory usage of one or more sparse portions of the collection of bit-arrays, and the decompression circuits are enabled to reverse effects of the compression circuits to decompress information for use in in-memory array-wide bit-wise operations.

9. The method of claim 7, wherein the in-memory processing is further implemented at least in part via dedicated circuits enabled to calculate operations on compressed bit-arrays and to produce results of the operations as one or more or compressed bit-arrays.

10. The method of claim 9, wherein the dedicated circuits are implemented at least in part using an ASIC and/or an FPGA.

11. A method for distributed machine learning, the method comprising:
in a RAM memory of a computing element, representing each of a plurality of directly indecomposable components of an idempotent algebra as a respective bit-array; and
in the RAM memory, performing computations comprising array-wide bit-wise operations on one or more portions of one or more of the respective bit-arrays.

12. The method of claim 11, wherein the idempotent algebra is a semilattice.

13. The method of claim 11, wherein the array-wide bitwise operations comprise any combination of OR, AND, and NOT array-wide bitwise operations.

14. The method of claim 11, wherein one or more algebraic machine learning co-processors comprise the computing element.

15. The method of claim 11, wherein at least one of the respective bit arrays is partitioned into a plurality of segments, each segment is stored in a respective memory bank of the RAM memory and the array-wide bitwise operations are carried out at least partially in parallel with respect to each of the segments.

16. The method of claim 11, wherein at least one of the respective bit arrays is partitioned into a plurality of segments, each segment is stored in a respective memory bank of the RAM memory and the array-wide bitwise operations are carried out independently with respect to each of the segments.

17. The method of claim 11, wherein the performing computations is implemented at least in part via one or more memory banks of the RAM memory, and the memory banks are comprised in dedicated hardware that is usable as a machine learning co-processor.

18. The method of claim 17, wherein the performing computations is further implemented at least in part via one or more compression circuits and one or more decompression circuits, the compression circuits are enabled to reduce memory usage of one or more sparse portions of the respective bit-arrays, and the decompression circuits are enabled to reverse effects of the compression circuits to decompress information for use in in-memory array-wide bit-wise operations.

19. The method of claim 17, wherein the performing computations is further implemented at least in part via dedicated circuits enabled to calculate operations on compressed bit-arrays and to produce results of the operations as one or more or compressed bit-arrays.

20. The method of claim 19, wherein the dedicated circuits are implemented at least in part using an ASIC and/or an FPGA.
